(19) United States
(12) Patent Application Publication
(10) Pub. No.: US 2021/0249881 A1
(43) Pub. Date: Aug. 12, 2021

(54) MOUNTABLE LAPTOP PORTABLE CHARGER

(71) Applicant: Irtaza Abbas Razvi, Jericho, NY (US)

(72) Inventor: Irtaza Abbas Razvi, Jericho, NY (US)

(21) Appl. No.: 17/081,150

(22) Filed: Oct. 27, 2020

Related U.S. Application Data
(63) Continuation-in-part of application No. 16/789,403, filed on Feb. 12, 2020.

(51) Int. Cl. H02J 7/00; G06F 1/16

(52) U.S. Cl. CPC H02J 7/0044; H02J 2207/30; H02J 2310/22; G06F 1/1635

(57) ABSTRACT

The mountable laptop portable charger provides a power source to a computing system. The device has a central case and a plurality of attachment arms having a first end coupled to the central case and a second end coupled to an attachment clip. The central case has a cavity to hold a power source to be connected to the computing system. The attachment arms may be rigid arms, folding arms, stretchable attachment cables or retractable attachment cables. The central case also may be sized to match the dimensions of a laptop display allowing attachment clips or grooves that are part of the central case to engage the display device to hold the central case in place.

### CROSS-REFERENCE TO RELATED APPLICATION

This application claims priority to U.S. patent application Ser. No. 16/789,403, titled “Mountable Laptop Portable Charger,” and filed on Feb. 12, 2020. The entire application is incorporated herein by reference in its entirety.

### TECHNICAL FIELD

This application relates in general to an article of manufacture for providing a mountable laptop portable charger.

### BACKGROUND

Users of laptops and mobile devices such as tablet computers depend upon an ability to provide and maintain power to run the devices. Laptops have internal batteries which are rechargeable and are able to run the devices without being plugged into an AC outlet. The internal batteries are recharged when the laptops are connected to a power source, which typically is an AC-to-DC power converter that is plugged into a wall outlet. The external batteries also may be recharged when the laptops are plugged into an external battery that provides the same DC voltage as the power converter.

Use of either of these types of power sources require that a charging device needs to be close enough to the laptop to permit the DC power cable to be plugged into the power input connector. These cables and power converters or batteries may present limitations to the location where the user may use the laptop. Providing a mechanism to easily attach these power sources to the laptop would make use of the laptop more convenient. However, attaching or restraining the power sources should be in a location that keeps the power source out of the way of the user while remaining easy to attach and remove from the laptop when the external power source is not needed.

The present invention attempts to address the existing limitations in attaching a power source for a laptop computer according to the principles and example embodiments disclosed herein.

### SUMMARY

In accordance with the present invention, the above and other problems are solved by providing an article of manufacture for providing a mountable laptop portable charger.

In one embodiment, the present invention is a mountable laptop portable charger device for providing a power source to a computing system. The device includes a central case, the central case having a cavity to hold a power source to be connected to the computing system and a plurality of attachment devices coupled to the central case, each attachment device having an attachment clip to hold the device to outer edges of a laptop display device.

In another aspect of the present disclosure, the plurality of attachment devices comprise an attachment arm having a first end coupled to the central case and a second end coupled to the attachment clips.

In another aspect of the present disclosure, the attachment arms are extendable in length to reach the outer edges of a laptop display device.

In another aspect of the present disclosure, the attachment arms are telescoping arm having locking devices to hold the attachment arms at a set position.

In another aspect of the present disclosure, the attachment arms slide outward from the central case having a restraining attachment to the central case configured to hold the attachment clip about the outer edge of the laptop display device while supporting the central case.

In another aspect of the present disclosure, the attachment clips are coupled directly to outer edges of the central case along opposing sides and the central case being sized to match the width of the laptop display device permitting the attachment clips to be coupled to opposing sides of the laptop display device.

In another aspect of the present disclosure, the attachment clip comprise an attachment tab extending outward from the attachment clip to engage a front surface of the laptop display device while the central case is positioned against a back surface of the laptop display device.

In another aspect of the present disclosure, the plurality of attachment devices being mounted on a back surface of the central case and directly engage a back surface of the laptop display device.

In another aspect of the present disclosure, the plurality of attachment devices comprise one or more attachment devices including Velcro™, magnets, double sided tape, suction cups, and the like.

In another aspect of the present disclosure, the attachment devices further comprise a third attachment arms having a first end coupled to the central case and a second end coupled to the attachment clips, the third attachment arm being coupled to the central case by pivoting attachment point on a top edge of the central case.

In another aspect of the present disclosure, the attachment clips comprise a pair of attachment grooves along outer side edges of the central case, the attachment grooves engaging opposite sides of the laptop display device after sliding down the edges of the laptop display device.

In another aspect of the present disclosure, the central case is sized to match the width of the laptop display device permitting the attachment grooves to simultaneously engage both sides of the laptop display device.

In another aspect of the present disclosure, the attachment grooves comprise an attachment tab along a portion of the attachment groove for engaging a front surface of the laptop display device while the central case is positioned against a back side of the laptop display device

In another aspect of the present disclosure, the attachment grooves further comprise an end stop located before the attachment grooves reach a top edge of the central case, the end stop engages a top edge of the laptop display device when fully installed.

In another aspect of the present disclosure, the central case further comprises an attachment port for providing an electrical connection from the battery to the laptop device.

In another aspect of the present disclosure, wherein the attachment port comprises a USB-A connector, a micro-USB connector, a mini-USB connector, a USB-C connector, and a dedicated power connector.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It also should be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-f illustrate one potential embodiment of an article of manufacture for a mountable laptop portable charger according to the present invention.

FIGS. 2a-c illustrate another possible embodiment of a mountable laptop portable charger according to the present invention

FIGS. 3a-c illustrate a third possible embodiment of a mountable laptop portable charger according to the present invention.

FIGS. 4a-m illustrate a fourth possible embodiment of a mountable laptop portable charger according to the present invention.

### DETAILED DESCRIPTION

This application relates in general to an article of manufacture for providing a mountable laptop portable charger.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations the functions and acts noted may occur out of the order noted in the figures. For example, two figures shown in succession may in fact be executed substantially concurrently or may sometimes be executed in the reverse order, depending upon the functionality and acts involved.

The term “laptop” refers to a mobile computing device having a screen for presenting images to users while operating the device. “Tablets,” “iPads™,” “Surface,™” “Nook™”, “Kindle™” and similar devices in which a user utilizes a touch screen to provide input signals to the device also may be some of the many possible embodiments for the claimed invention. All of the above terms may be used interchangeably without deviating from the scope of the invention as defined in the attached claims.

The term “user” and “individual” refers to an entity, e.g. a human, that operates a device according to the present invention in order to bring about a desired effect or outcome, particularly to provide the user an ability to support an instrument. In a particular case, the user is one that is using a laptop. For such a user, the terms “user” and “individual” may be used herein interchangeably.

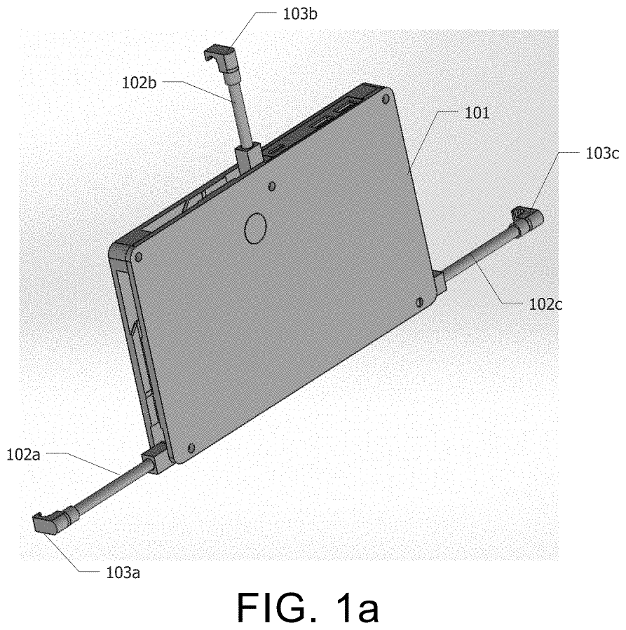

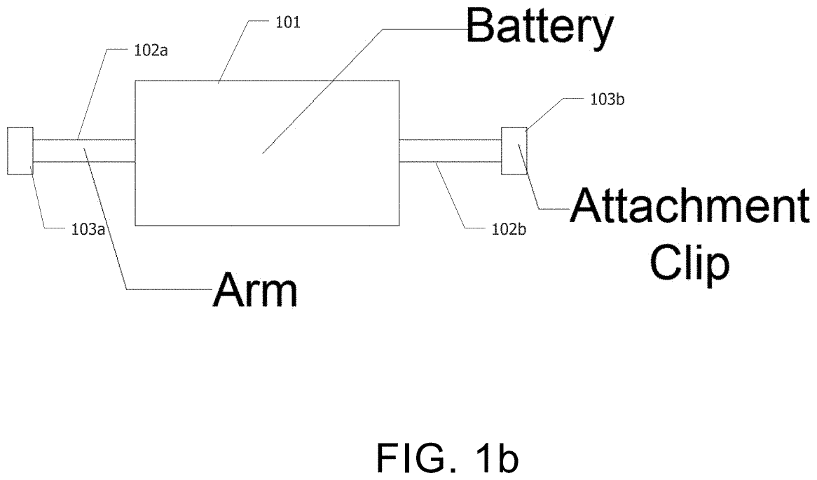

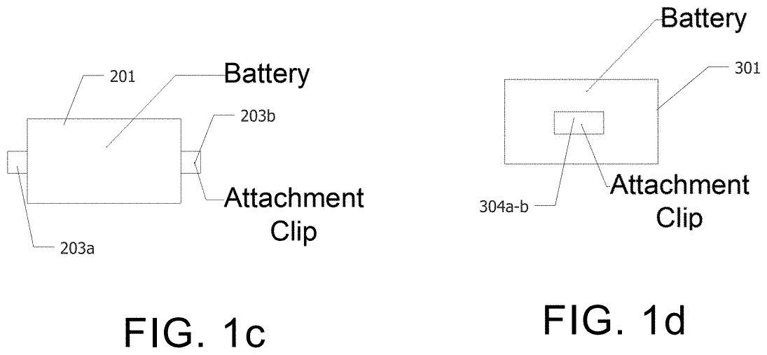

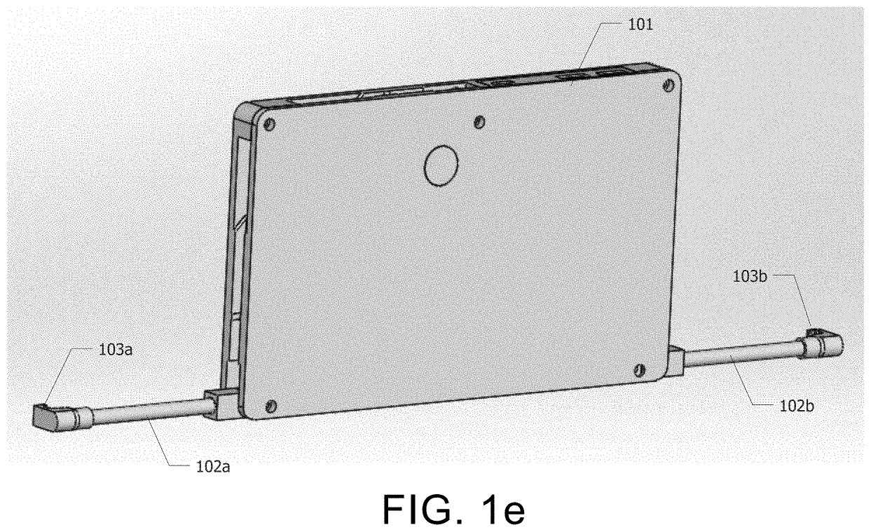

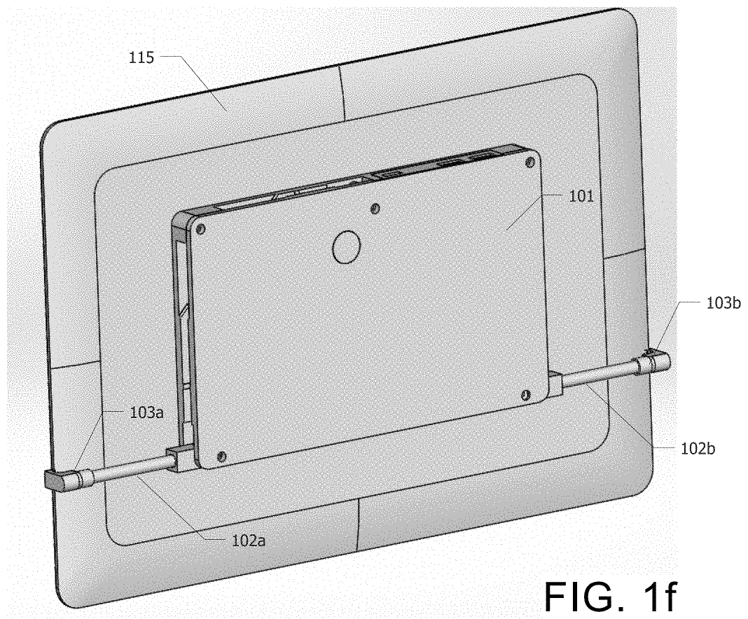

In general, the present disclosure relates to an article of manufacture for providing a mountable laptop portable charger for restraining a power source to a computing device such as a laptop and tablet. To better understand the present invention, FIGS. 1a-d illustrate one potential embodiment of an article of manufacture for a mountable laptop portable charger according to the present invention. FIG. 1a shows a first embodiment of the present invention comprising a central case 101 containing a power source, such as a battery, and a plurality of attachment arms 102a-c having attachment clips 103a-c on their respective ends to couple to a laptop display. In this embodiment, the attachment arms 102a-c are coupled to the central case 101 in a manner that permits them to be stored along the outer edges of the central case 101 when not in use. Two of the attachment arms 102a, 102c are coupled to lower corners of the central case and may pivot to align the attachment arms 102a-c along the edge of the central case. The remaining attachment arm 102b is coupled to the center of an edge of the central case 101 and pivots downward toward the central case 101 in a similar manner.

FIG. 1b shows a generic depiction of the first embodiment of the present invention. The central case 101 has a pair of attachment arms 102a-b extending outward from opposing sides of the central case 101. Attachment clips 103a-b are located on the outer ends of the attachment arms 102a-b for coupling to the sides of a display device. In this embodiment, the attachment arms 102a-b typically are variable in length and apply an inward force against the attachment clips 103a-b when the clips are coupled to the edge of a display device. The amount of force exerted by the attachment arms 102a-b must be sufficient to support the weight of the central case 101 and any battery inside. The attachment arms 102a-b may utilize any number of mechanisms to vary their length while exerting the needed force and include telescoping arms, stretchable arms, extending and locking arms, and rigid arms sized to match a particular-sized display device.

FIG. 1c-d shows a central case having a pair of attachment clips. FIG. 1c shows a pair of attachment clips 203a-b on either side of the central case 210 in which the attachment clips 203a-b engage the outer edge of the laptop display device (not shown). FIG. 1d shows the central case 301 having at least one attachment device 304 located in the middle of one of the surfaces of the central case. The attachment device 304 couples to the back surface of the laptop display device (not shown).

FIG. 1e shows a central case 101 with a pair of attachment arms 102a-b coupled to opposing lower corners of the central case 101 that extend their respective attachment clips 103a-b a set distance from the central case 101. Fig. if shows the embodiment of FIG. 1c when the attachment clips 103a-b are coupled to the outer edges of the display device 115 of a laptop. The attachment clips 103a-b hold the attachment arms 102a-b in place while holding the central case 101 out of the way and above the bottom of the display device 115 as is rests on a tabletop.

The central case 101 typically has an attachment port (not shown) for providing an electrical connection from the battery to the laptop device. The attachment port may utilize any viable connectors, including USB-A, micro-USB, mini-USB, USB-C, and similar connections. A power cable (not shown) may run from the attachment port to the power in connector on the laptop to provide electrical power to operate the computing device.

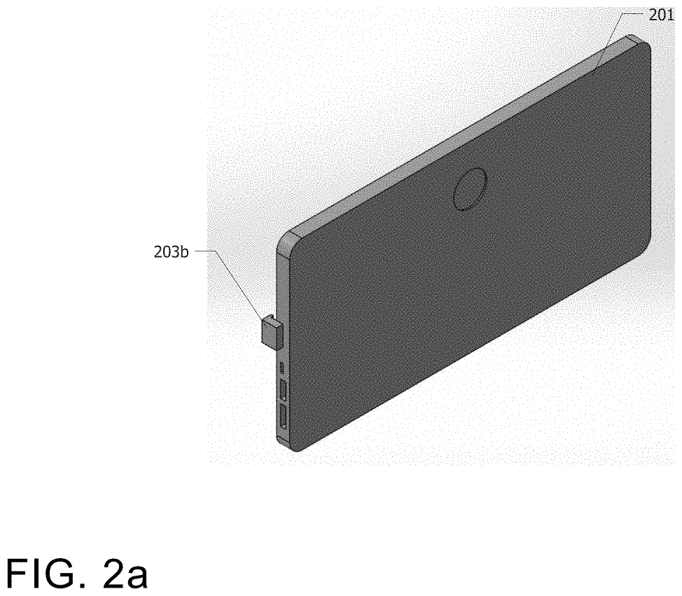

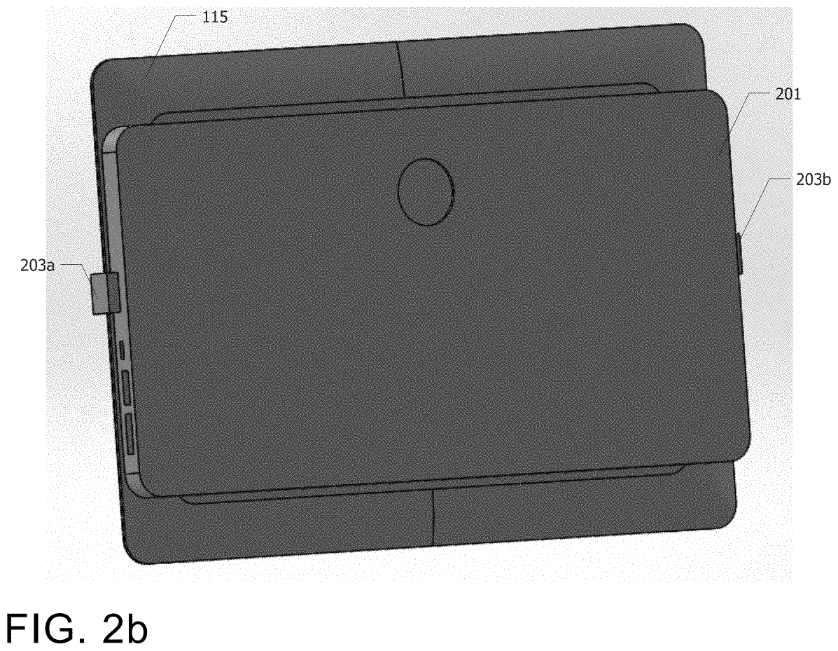

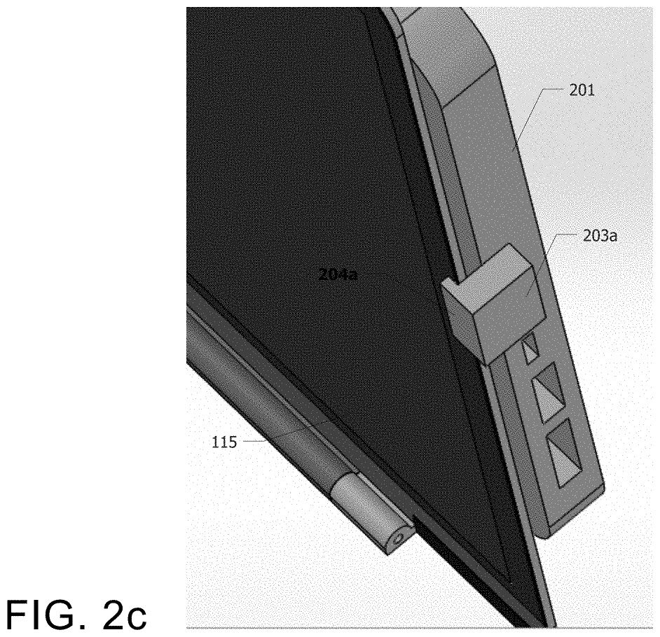

FIGS. 2a-c illustrate another possible embodiment of a mountable laptop portable charger according to the present invention. FIG. 2a shows a similar embodiment of the present invention having a central case 201 and a pair of attachment clips 203a-b coupled directly to the outer edge of opposing sides of the central case 101. From this perspective view only attachment clip 203b is visible; however, an identical clip to 203b, denoted as 203a is located on the opposite side. In this embodiment, the central case 201 itself is sized to match the width of the display device 115, as shown in FIG. 2b. The attachment clips 203a-b couple to the outer edge of the display device 115 in a similar manner as described above. FIG. 2c shows one of the attachment clips 203a having an attachment tab 204a extending inward from the attachment clip 203a to engage a front surface of the display device 115 while the attachment clip 203a is sized to place the central case 201 against the rear surface of the display device 115 where the two surfaces of the clip/case hold the edge of the display device 115.

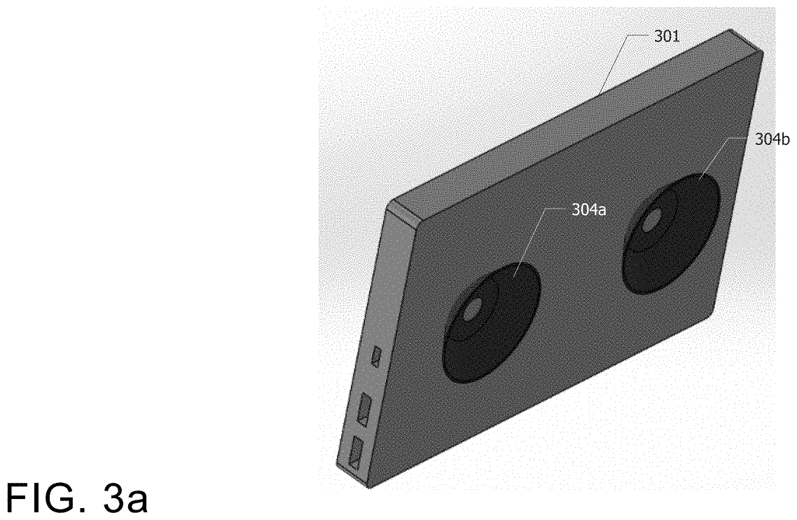

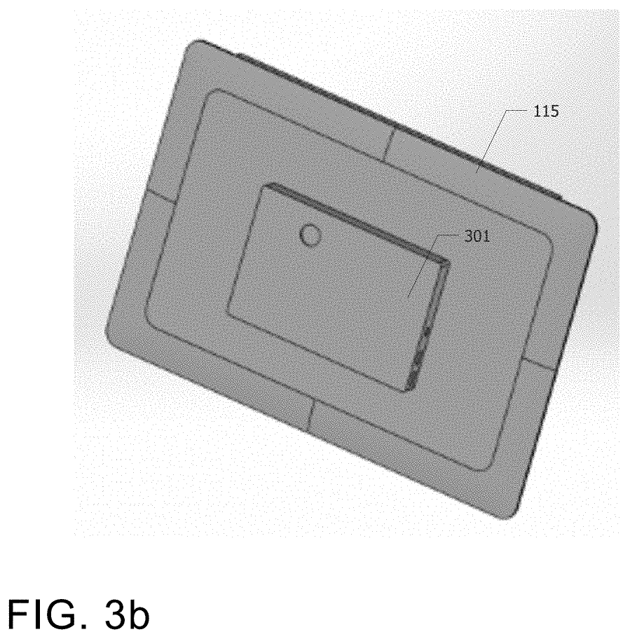

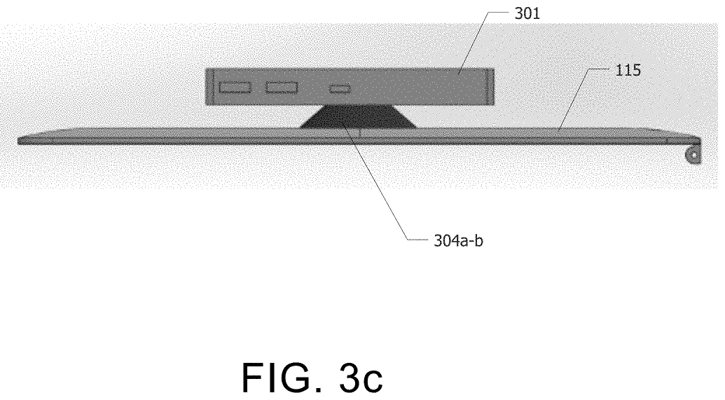

FIGS. 3a-c illustrate a third possible embodiment of a mountable laptop portable charger according to the present invention. FIG. 3a shows another possible embodiment of the present invention having a central case 301 and a pair of attachment devices 304a-b located on an inner surface of the central case 101. In FIG. 3a, the attachment devices 304a-n comprise Velcro™, magnets, double sided tape, suction cups, and the like that may engage a back surface of a display device 115 as shown in FIGS. 3b-c.

FIG. 3b shows a rear view of the central case 301 coupled to the back surface of the display device 115 in a similar location as discussed above. FIG. 3c shows a side view of the central case 301 having the attachment devices 304a-n located between the central case 301 and the display device. When the retention force of the attachment devices 304a-b is sufficient to support the weight of the central case and any battery of other power source therein, no other attachment mechanism may be needed.

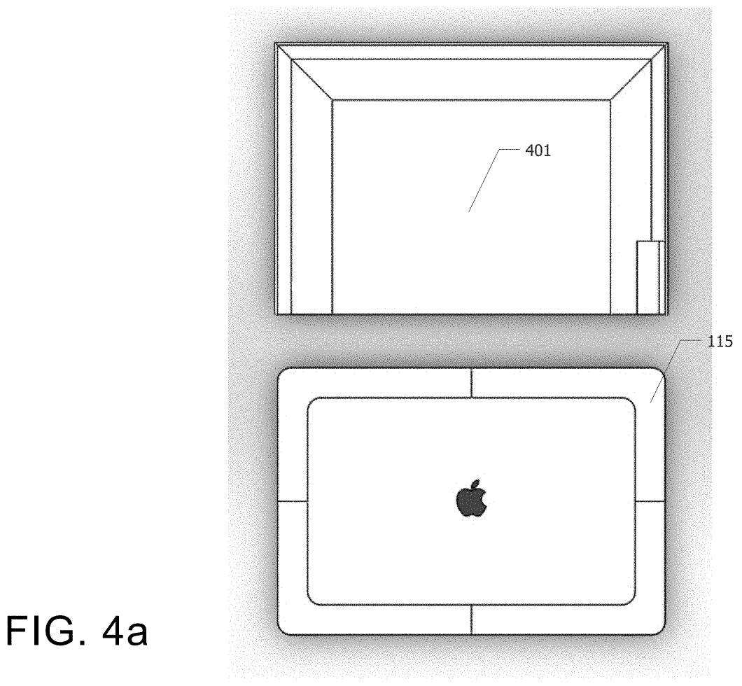

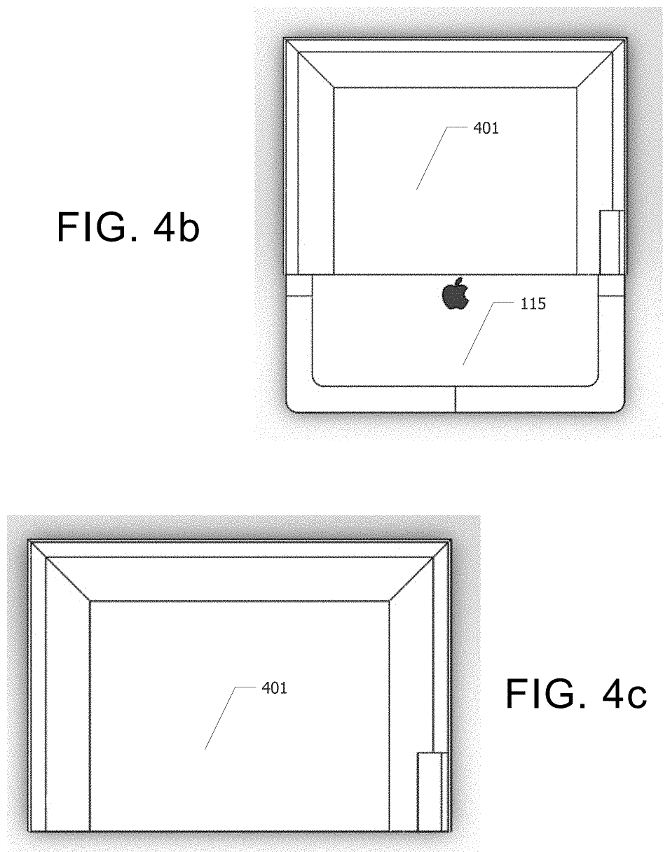

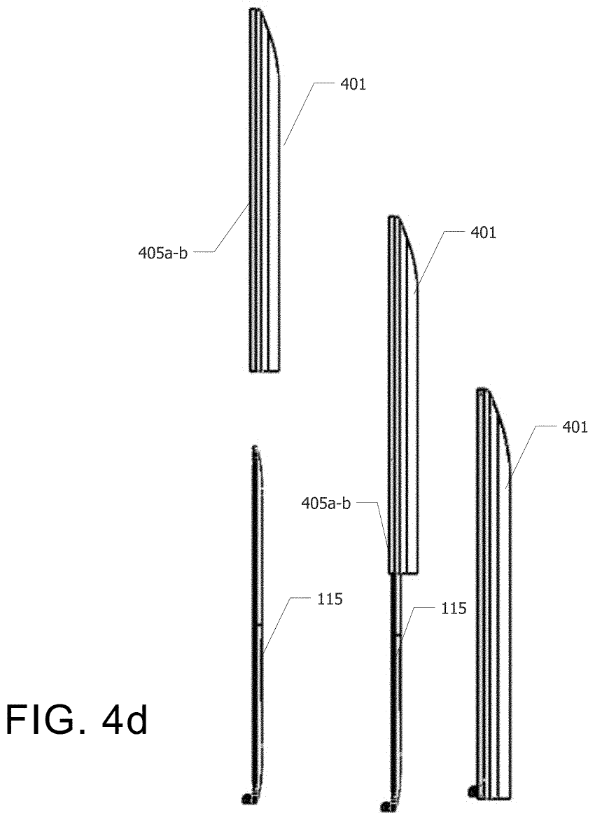

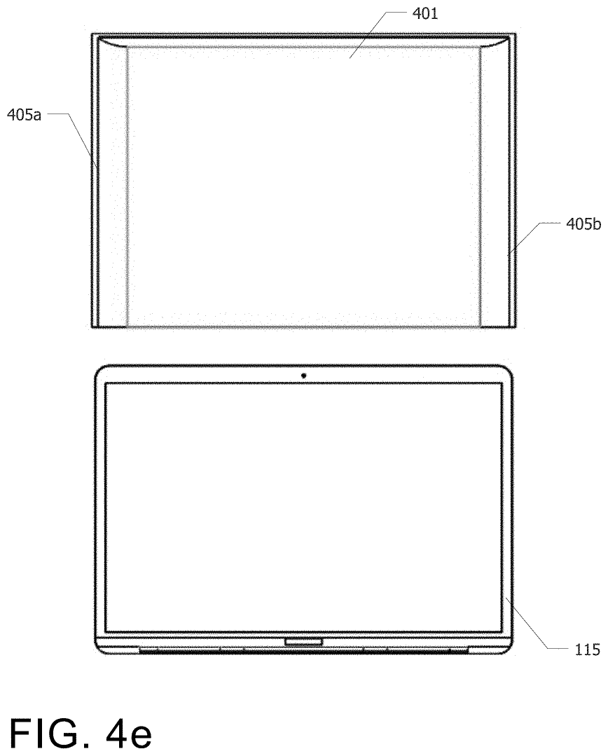

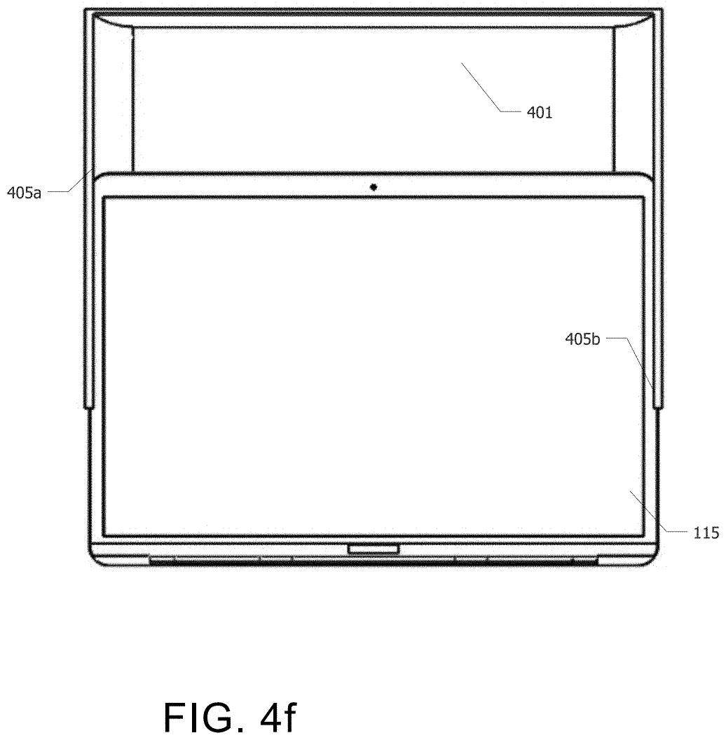

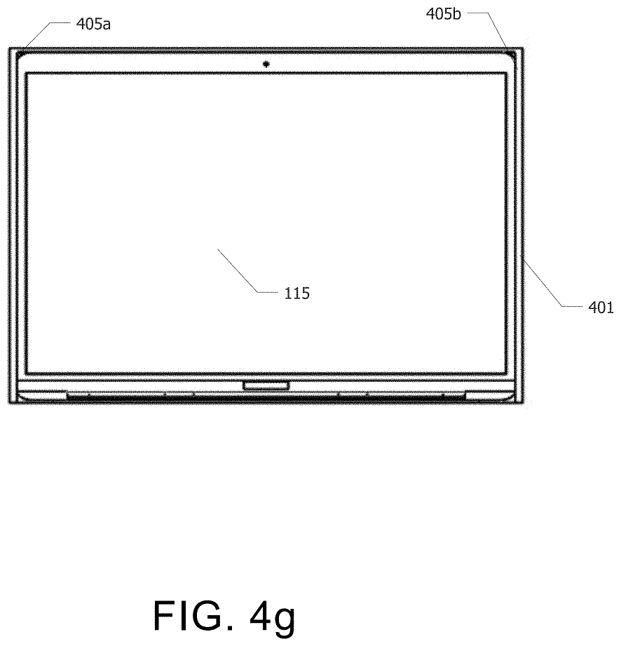

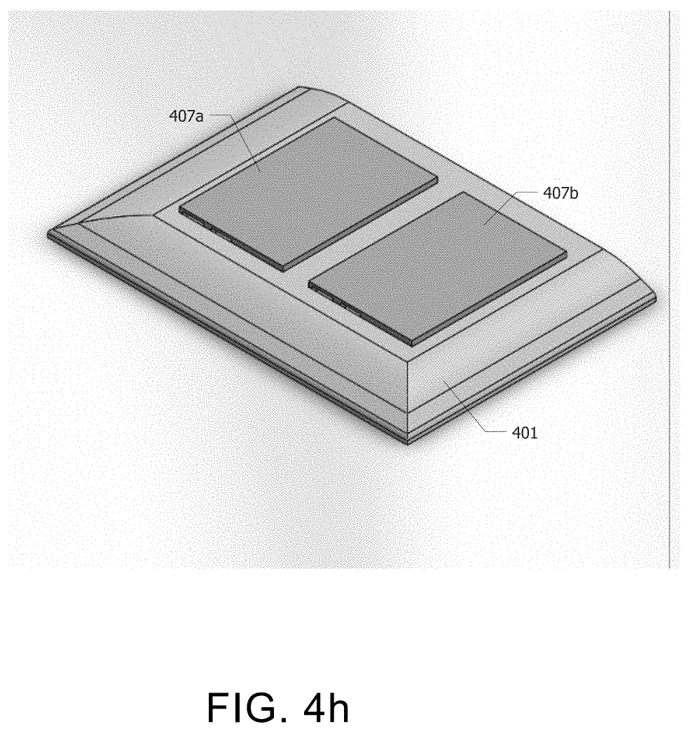

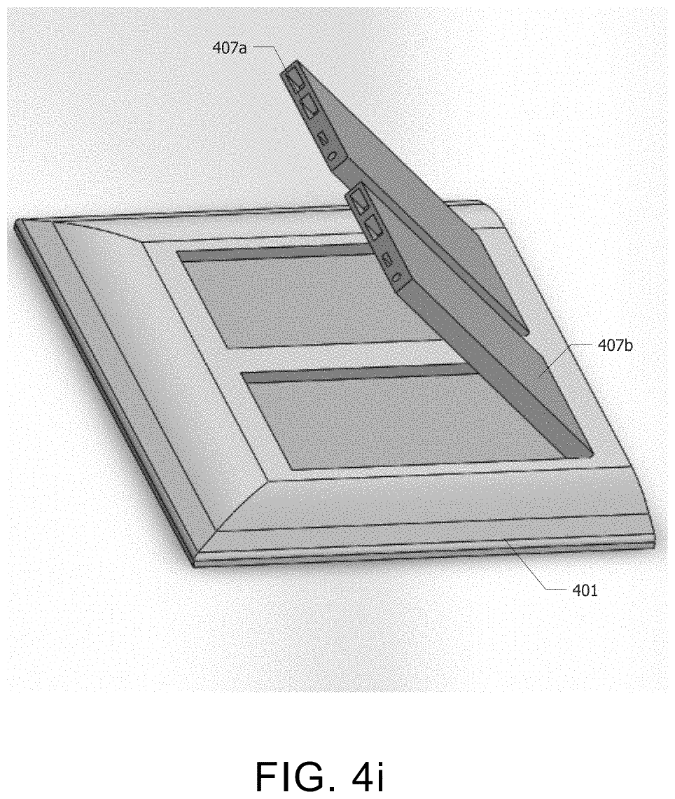

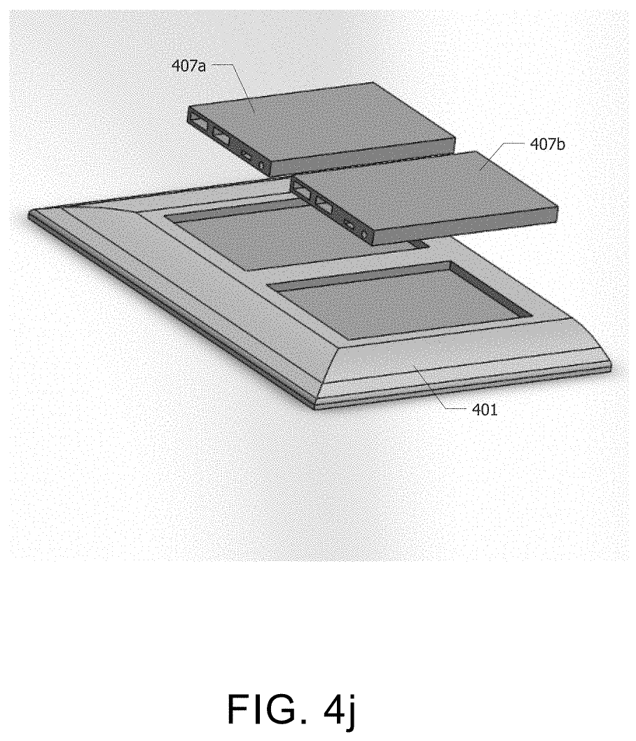

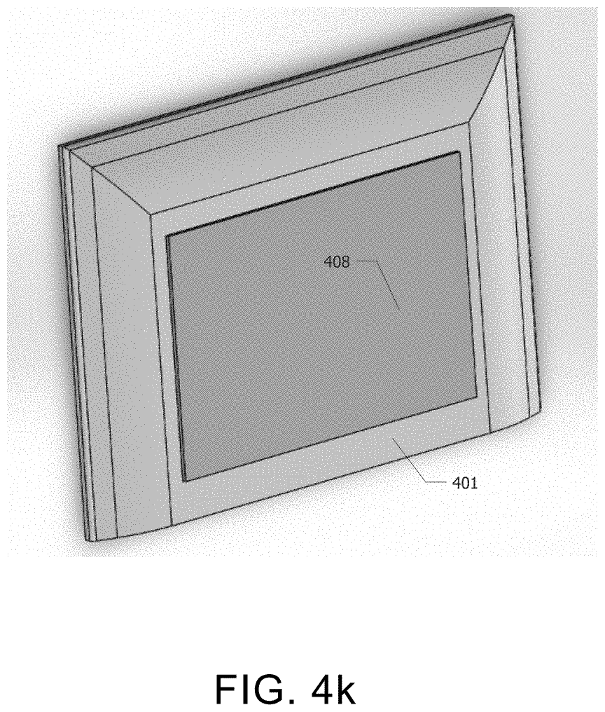

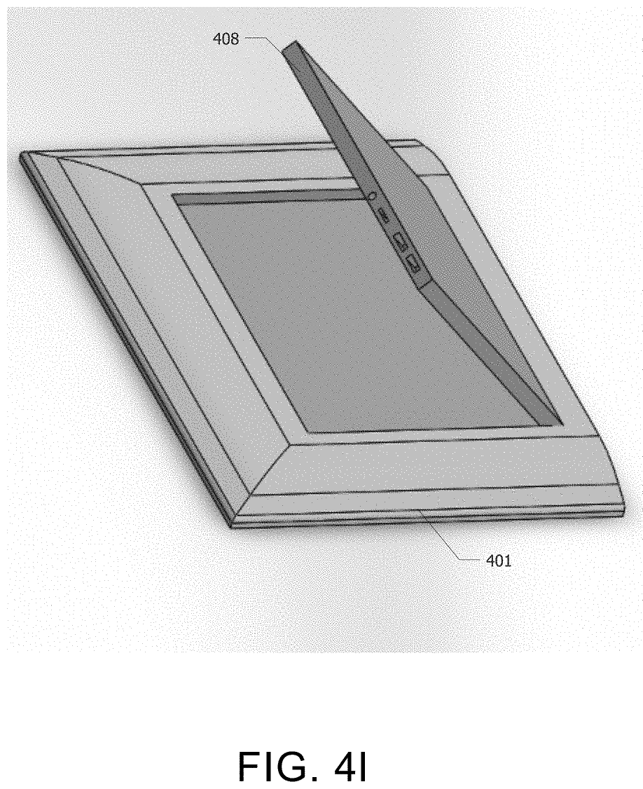

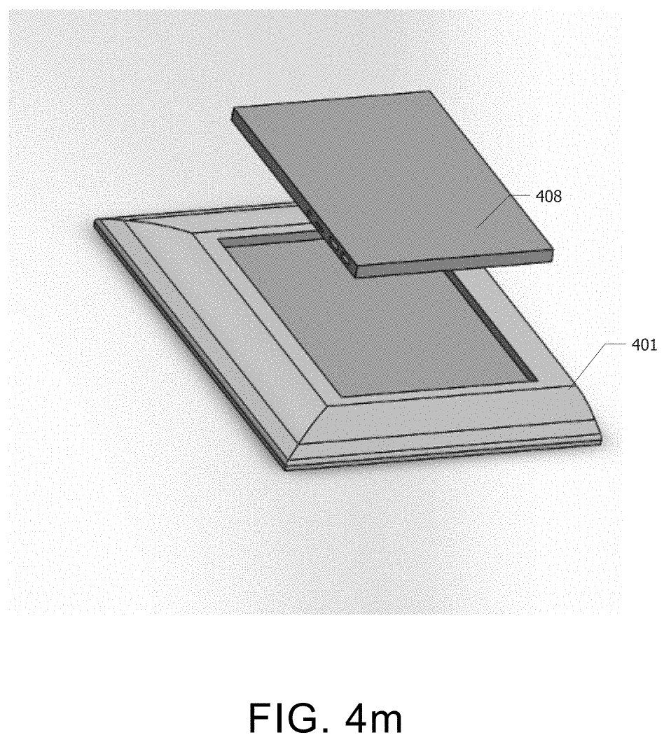

FIGS. 4a-m illustrate a fourth possible embodiment of a mountable laptop portable charger according to the present invention. FIG. 4a shows side view of the present invention having a central case 401 that couples to opposing outer edges of the display device. FIG. 4b shows the side view of the central case 401 being slid onto the outer side of the display device. FIG. 4c shows the side view of the central case 401 once it has been fully installed onto the display device 115. The central case 401 is once again sized to match the size and shape of the particular display device 115 where a specific central case 401 containing a power source is needed for each model of laptop as they typically have slightly different display device 115 dimensions.

The opposing edges of the central case 401 include a pair of attachment grooves 405a-b on opposing sides of the central case. The attachment grooves 405a-b include a tab similar to the attachment clip shown in FIG. 2c that permits the outer opposing edges of the display device 115 to slide within the attachment grooves 405a-b in which the tabs engage the front surface of the display device 115 while the central case 401 is held against the back surface of the display device 115, thus holding the central case 401 in place. The attachment grooves 405a-b further comprise an end stop located before the attachment grooves 405a-b reach a top edge of the central case, the end stop engages a top edge of the laptop display device 115 when fully installed.

FIG. 4e-g show the central case 401 as if is oriented and placed onto laptop 115 using the attachment grooves 205a-b from a front view that corresponds to the embodiment of FIGS. 4a-d. FIGS. 4h-j shown an embodiment of the central case 401 having a pair of removable batteries 407a-b that attach to the central case 401. The pair of removable batteries 407a-b are rechargeable batteries that may be charges using an external charger, not shown, and then inserted into the central case 401 for use. Figs. k-m shown an embodiment of the central case 401 having a single removable batteries 408 that attach to the central case 401 similar to the pair of batteries 407a-b discussed above. When these batteries are removed, they can be used as regular portable chargers as well. They function as an on the go phone charger and an on the go laptop charger.

As noted above, the central case 201, 301, 401 also typically have an attachment port (not shown) for providing an electrical connection from the battery to the laptop device. The attachment port may utilize any viable connectors, including USB-A, micro-USB, mini-USB, USB-C, a dedicated power connector, and similar connections. A power cable (not shown) may run from the attachment port to the power in connector on the laptop to provide electrical power to operate the computing device.

As above, this embodiment may function in similar ways as any of the other embodiments. These variations permit batteries and power converters to be stored in the central case 101, permit attachment mechanisms to include corner connectors and u-shaped clips in addition to the suction cups, and similar attachment mechanisms, and permit various materials to be used for the attachment arms as defined in the attached claims.

One of ordinary skill will recognize that the attachment mechanism may use any number of means to couple the central case to the laptop screen. In the various embodiments, the attachment mechanisms include a corner connector, a u-shaped clip, and a suction cup. Other attachment mechanisms also may include pads attached to attachment arms or attachment cables that couple the pads to the laptop screen using other removable mechanisms such as Velcro™, double-sided tape, rubber cement and similar adhesives, hooks, linear track locks, and related means. Additionally, the attachment arms are shown to be solid and foldable arms, stretchable cables, and retractable cables using a variety of pulley arrangements. These mechanisms and similar means to connect the central case to the outer edge of the laptop screen to support the weight of the central case also may be used. In all of these variations, the present invention is limited by only the limitations recited in the attached claims.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A mountable laptop portable charger device for providing a power source to a computing system, the device comprises:
a central case, the central case having a cavity to hold a power source to be connected to the computing system; and
a plurality of attachment devices coupled to the central case, each attachment device having an attachment clip to hold the device to outer edges of a laptop display device.

2. The mountable laptop portable charger device according to claim 1, wherein the plurality of attachment devices comprise an attachment arm having a first end coupled to the central case and a second end coupled to the attachment clips.

3. The mountable laptop portable charger device according to claim 2, wherein the attachment arms are extendable in length to reach the outer edges of a laptop display device.

4. The mountable laptop portable charger device according to claim 3, wherein the attachment arms are telescoping arm having locking devices to hold the attachment arms at a set position.

5. The mountable laptop portable charger device according to claim 3, wherein the attachment arms slide outward from the central case having a restraining attachment to the central case configured to hold the attachment clip about the outer edge of the laptop display device while supporting the central case.

6. The mountable laptop portable charger device according to claim 1, wherein the attachment clips are coupled directly to outer edges of the central case along opposing sides; and
the central case being sized to match the width of the laptop display device permitting the attachment clips to be coupled to opposing sides of the laptop display device.

7. The mountable laptop portable charger device according to claim 6, wherein the attachment clip comprise an attachment tab extending outward from the attachment clip to engage a front surface of the laptop display device while the central case is positioned against a back surface of the laptop display device.

8. The mountable laptop portable charger device according to claim 1, wherein the plurality of attachment devices being mounted on a back surface of the central case and directly engage a back surface of the laptop display device.

9. The mountable laptop portable charger device according to claim 8, wherein the plurality of attachment devices comprise Velcro™, magnets, double sided tape, suction cups, and the like.

10. The mountable laptop portable charger device according to claim 9, wherein the attachment devices further comprise a third attachment arms having a first end coupled to the central case and a second end coupled to the attachment clips, the third attachment arm being coupled to the central case by pivoting attachment point on a top edge of the central case.

11. The mountable laptop portable charger device according to claim 1, wherein the attachment clips comprise a pair of attachment grooves along outer side edges of the central case, the attachment grooves engaging opposite sides of the laptop display device after sliding down the edges of the laptop display device.

12. The mountable laptop portable charger device according to claim 11, wherein the central case is sized to match the width of the laptop display device permitting the attachment grooves to simultaneously engage both sides of the laptop display device.

13. The mountable laptop portable charger device according to claim 12, wherein the attachment grooves comprise an attachment tab along a portion of the attachment groove for engaging a front surface of the laptop display device while the central case is positioned against a back side of the laptop display device.

14. The mountable laptop portable charger device according to claim 13, wherein the attachment grooves further comprise an end stop located before the attachment grooves reach a top edge of the central case, the end stop engages a top edge of the laptop display device when fully installed.

15. The mountable laptop portable charger device according to claim 1, wherein the central case further comprises an attachment port for providing an electrical connection from the battery to the laptop device.

16. The mountable laptop portable charger device according to claim 15, wherein the attachment port comprises a USB-A connector, a micro-USB connector, a mini-USB connector, a USB-C connector, and a dedicated power connector.
